(19) United States
(12) Patent Application Publication
(10) Pub. No.: US 2016/0056971 A1
(43) Pub. Date: Feb. 25, 2016

(54) WIRELESS LIGHTING CONTROL

(71) Applicant: RF Digital Corporation, Hermosa Beach, CA (US)

(72) Inventor: Armen E. Kazanchian, Hermosa Beach, CA (US)

(21) Appl. No.: 14/835,669

(22) Filed: Aug. 25, 2015

Related U.S. Application Data
(60) Provisional application No. 62/041,580, filed on Aug. 25, 2014.

(51) Int. Cl. H04L 12/28; H05B 37/02

(52) U.S. Cl. CPC H04L 12/2816; H05B 37/0272; H04L 12/2809; H04L 2012/2849; H04L 2012/2841

(57) ABSTRACT

Exemplary embodiments include a wireless lighting system. Exemplary embodiments also include systems and methods for automatically configuring and/or mapping nodes within a system of nodes for control by a single and/or remote device.

### PRIORITY

This application claims priority to U.S. Application No. 62/041,580, filed Aug. 25, 2014, which is incorporated by reference in its entirety into this application.

### BACKGROUND

Historically, the way lighting works is you have an electrical current that is run from the power mains, in series through a wall switch and ultimately to lights mounted in a ceiling of a home or office and in different rooms.

In recent years, for power conservation and the demand for “smart” homes and “smart” offices, the demand for users to selectively control lighting is very significant. However, the installation of these systems makes them prohibitive without the need for a trained professional to conduct a very complex installation process. This process may include manually mapping the configuration of every light in the building to the specific light switches and manually recording their locations, so when you have a kitchen light switch, it will control the kitchen light and not the light in the living room.

### SUMMARY

Embodiments described herein may be used as a way to provide wireless communication between lights and a controller. Exemplary embodiments may also permit communication between individual lights, such that they may be able to assist or automate the installation process. Exemplary embodiments include a Wireless Lighting Control System. Embodiments may use a micro size, wireless RF module that has Ultra Low Power Bluetooth smart-phone connection and also point to multi-point communication, which may be used too easily install (deploy) a wireless lighting control system.

### DRAWINGS

FIG. 1 illustrates an exemplary light node of a lighting system according to embodiments described herein.

FIG. 2 illustrates an exemplary RF module according to embodiments described herein.

FIG. 3 illustrates an exemplary controller according to embodiments described herein.

### DESCRIPTION

Currently, deploying a wireless lighting system is labor intensive and requires a lot of time and technical understanding. Embodiments described herein may include a self-adapting design that is automatic and done in minutes. The system may be easy to deploy and customized as the lights may be controlled wirelessly, such as through a mobile or electronic device that does not necessitate a physical light switch. For example, in the lasso light switch association described herein, an advantage is achieved by allowing a user to easily add more light switches wherever they want in a home without re-associating the entire or portions of the system again manually. Thus, the system may be dynamically customizable.

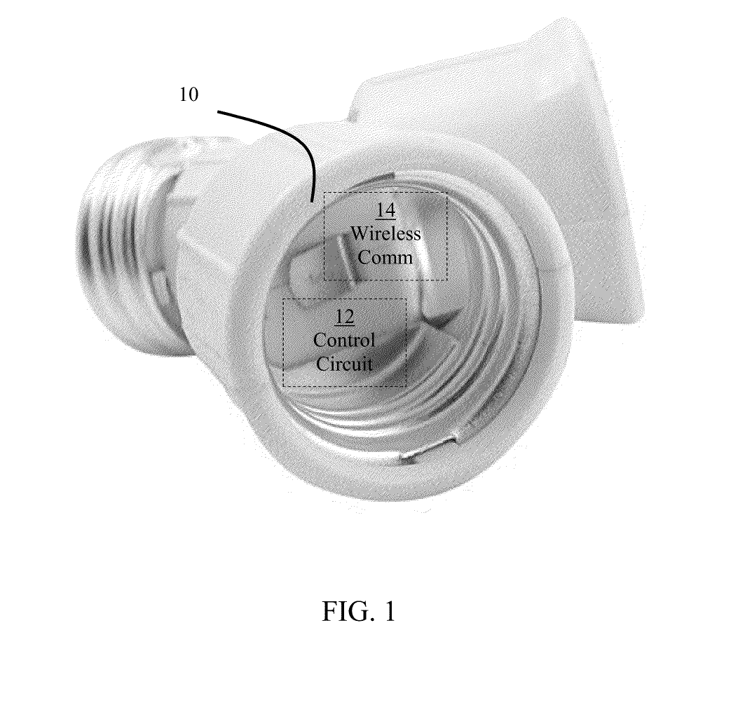

As seen in FIG. 1, in an exemplary embodiment, the lighting and control system may comprise a light node 10 having a housing that encloses a wireless communication device 14 and control circuit 12. The housing may take on any form convenient to the application such as a socket that may be mounted directly to a surface, or as an extension between an existing socket and the inserted light bulb. The wireless communication device 14 may be configured to receive and/or transmit signals from the light node, such as those for configuring and mapping the system to those for controlling the system. The control circuit may be used to control the current provided to the light bulb such that it may be turned off, on, or dimmed.

As shown, the extension housing may be configured to insert into a traditional light bulb socket and receive one or more light bulbs. The housing may include the electronics (as seen as dotted block diagram) to support the functions described herein. In an exemplary extension socket embodiment, the device may include the base of a light bulb on one end and the other end having a socket for a light bulb. The user then unscrews the traditional light bulb from the wired socket and screws in this “in between spacer” that physically separates the light bulb from the screw base. This spacer with the wireless electronics in it, also disrupts the flow of electricity and replaces it with an electronic switch that is controlled by the embedded wireless device in the sleeve. So the sleeve can cause the flow or disruption of flow of current to the light bulb, hence having control over turning it on and off, or even causing it to dim. In an exemplary embodiment, the sleeve itself is positioned upstream of the disrupting switch, and therefore has power applied to it constantly. The device therefore has the requisite power it needs to support the wireless device and other internal electronics which consume very little power. The light bulb itself may also be replaced. For example, by way of comparison, the traditional bulb of 100 watts may be replaced with an LED bulb of 20 watts, and the electronics would be less then 1/10 of a watt typically.

An alternate embodiment may include hardware located at the light itself. In this case, a small circuit board may be inserted or be enclosed with two power input wires and two output wires to the light. This would be typically used in an office florescent light box application and hard-wired in by disconnecting the two wires going to the light normally and interrupting that circuit right at the light with this new wireless hardware board and it would perform as described herein.

An alternate embodiment may include battery powered lights, or lights that use some sort of energy harvesting. These lights would not need any mains power at all. Also their power in that case and installation might come from wall transformers that supply power to small portable LED lighting panels which are becoming popular. In an exemplary embodiment, the device may be part of the light itself.

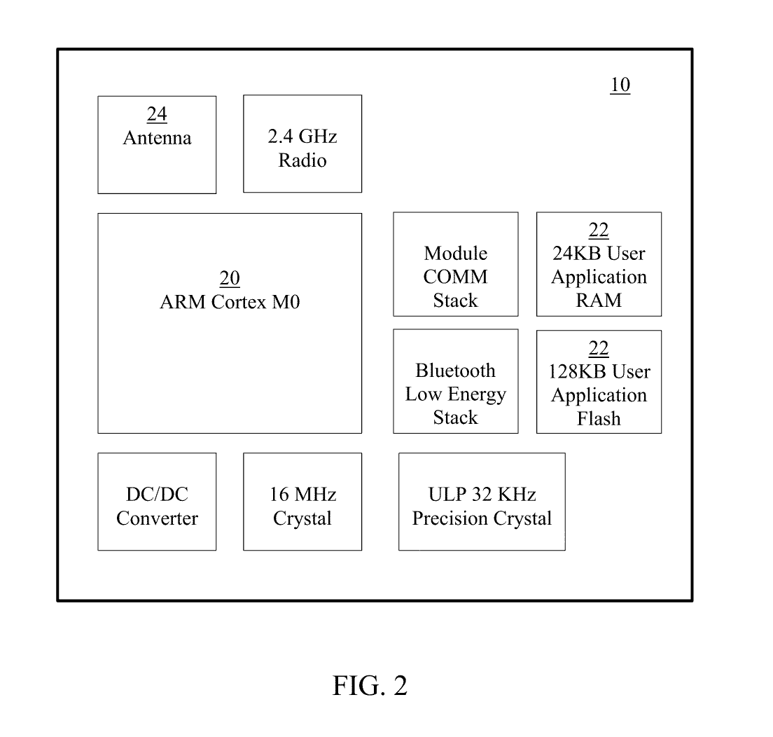

Embodiments described herein encompass an RF Wireless Lighting Control System. Embodiments may use a micro size, wireless RF module that has Ultra Low Power Bluetooth smart-phone connection and also point to multi-point communication, which may be used too easily install (deploy) a wireless lighting control system. As seen in FIG. 2, a communication module may be used at the light socket, in a light socket extension, or within the light itself. The communication module may include a processor 20 and memory 22 for performing the functions described herein for configuring and controlling the light. The module may include an antenna 24 for wireless communication with the controller.

Exemplary embodiments of the communication module includes a micro size, wireless RF Module that has Ultra Low Power Bluetooth smart-phone connection and also point to multi-point communication. Micro size may be determined by a person of skill in the art based on the physical object to which the RF Module is associated. For example, the RF Module may be micro sized if it is less than 25 mm×25 mm, or approximately 15 mm×15 mm. An exemplary RF Module may be the RFD22301 sold by RF Digital Corporation, which contains a radio transceiver and microprocessor having flash (non-volatile) memory. There is 128 k of user code space available inside of this module, and the user can load their own code (program) aimed at running in the microcontroller itself.

The communication device includes a wireless communicator, which can be one of any dozens of wireless Bluetooth Low Energy devices available in the world. Bluetooth is only exemplary, such as for use as a communication means to smartphones, other types of communication can be used. Although exemplary embodiments described herein use Bluetooth Low Energy to communicate between the light node and mobile device and/or controller, embodiments are not so limited as the communication devices do not need to use Bluetooth Low Energy. Bluetooth Low Energy is just one of the base protocols that may be use, but is not limited to any one protocol. For example, any wireless protocol can be used such as Bluetooth, Near Field Communication (NFC), WiFi, cellular, etc.

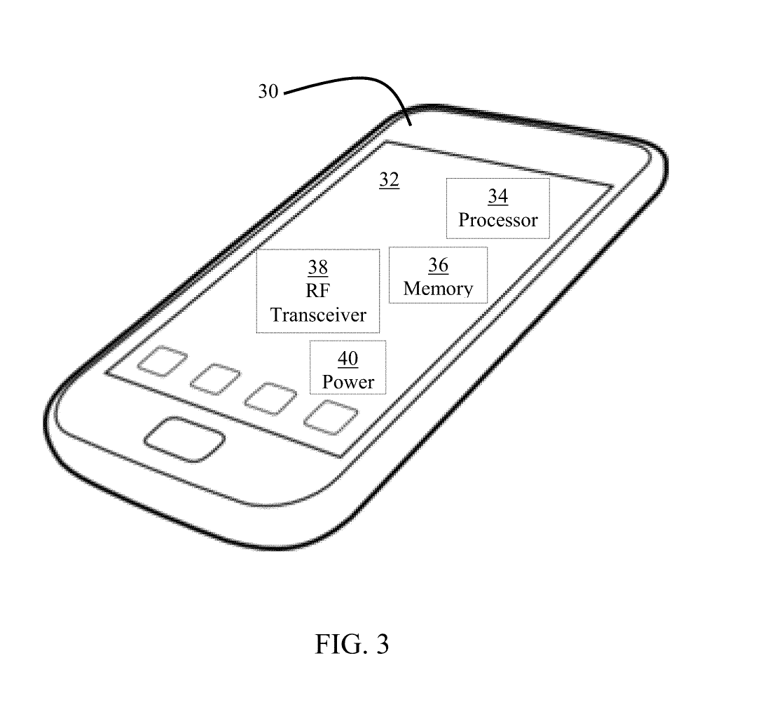

As seen in FIG. 3, the system may also comprise a control device 30. In an exemplary embodiment, the control device may be a mobile electronic device such as a tablet, smart phone, smart device, or may be a non-mobile electronic device such as PC or website. As shown, the control device 30 may comprise a display screen 32 for displaying controls or information about the lighting system to a user. The control device 30 may also include a processor 34, memory 36, wireless communication device 38, and power 40. The wireless communication device 38 is configured to communicate with the wireless communication device 14 of the light node 10. The processor 34 is configured to execute machine readable instructions stored on memory 36 to effect control and display functions as described herein.

Alternatively or in addition thereto, the control device can also be a portable light switch, which can mount with double stick tape to a wall or screwed into a wall without any wiring and run on batteries. The hardware in this case would be a light switch housing, a switch of some type that can be controlled by a person and the small, roughly 1 inch square PCB with the wireless electronics on-board that can all fit inside of a switch housing for wall mounting.

In an exemplary embodiment, the control system may also use the same wall switch that would normally turn the light on and off in that room. In this case, the wiring from the switch may be removed, bypassing the switch contacts and shorting the wires together to provide constant power to the lights in the room (which are controlled by the wireless nodes in the fixtures). Then power may be pulled from the light switch wall location to power the wireless device of around 1 inch in size that may connect to the light switch. So the light switch connects to this 1 inch board and that 1 inch board connects to the power in the wall.

In an exemplary embodiment, the wall switch wiring may be left alone. Therefore, the device embodiments described herein are powered by leaving the light switch on all the time to make sure power is flowing to the lights. The device is then controlled wirelessly through one or more control devices or systems described herein.

Accordingly, embodiments described herein may comprise a lighting and control system that attaches to the present hard wired electrical system of the building and replaces or supplements the present light socket. The replacement may be a change of hardware at the socket, or the supplement may be an inclusion of an extension between the traditional socket and the light or integration into the light itself. The exemplary embodiments are herein generally described as “socket,” which includes any described embodiment or equivalent embodiments thereto and are not limited to the traditional idea of a socket (i.e. such as the integration into the fixture itself). Embodiments of the device then wirelessly communicates with the other replaced sockets and/or the controller.

In an exemplary embodiment, each light may be individually controlled through a user interface that is provided by the light device. For example, each communication module may include software for sending user interface instructions to a mobile device for controlling the light within range or having a predominant signal to a mobile device. Exemplary user interface applications for displaying information and/or controlling a light device may be, for example, those described in co-pending application U.S. Ser. No. 14/834,302, filed Aug. 24, 2015, co-owned by the instant application, and incorporated by reference in its entirety into the present application.

In an exemplary embodiment, the system of light sockets communicates with each other to create a visual map to be controlled through a display or other switch interface. Once mapped, the individual lights are controlled through that display individually or as groups. Embodiments described herein may include all or any combination of the features described herein.

Embodiments of the device/socket may include a transmitter/receiver for either sending/receiving control signals to/from the mobile device, as well as possible communication between sockets for mapping. The mapping communication may include light sensors on each socket for detecting the presence of light from an adjacent socket. The sockets may include processors or control hardware/software to configure a sequential or random pattern of illumination so that adjacent sockets can determine a proximity and mapping to each other. Other mapping schemes are also possible in which the sockets have one or more other sensors for determining the distance/direction of adjacent sockets. For example, wireless communication signals can be intermittently patterned or randomly sent from each device at different intervals or coded to be recognized as unique to a given socket. These can be detected and distance/direction measured by adjacent sockets. This mapping or raw data can be sent to the mobile device for analysis and map display.

Once mapped, then the sockets receive control commands through the one or more transmitter/receiver components from the mobile device through interaction with the displayed map. The light detector sensor can be located in the light fixture, can optionally detect light in the room, light from a specific area, or the light emitted from the fixture itself.

Embodiments described herein may include methods for installing the wireless lighting control system described herein. For example, when wireless controlled lights according to embodiments described herein are installed, they can be powered on all at once for the first time, they can all go into an auto-mapping mode, where they can, randomly, yet with structure, wirelessly communicate with each other to and automatically measure distances from each other, which can create a map of their relative distances. This map can be displayed on a device like a tablet, iPhone, Android phone, computer or any other portable device with visual feedback to a user. This process can be very quick and requires nearly no user intervention.

In an exemplary embodiment, rooms may be mapped sequentially, such as one at a time. The graphical user interface on the mobile device may be used to position the rooms manually by moving squares that represent the rooms to position them relative to each other. Alternatively, the rooms may be named and accessed individually, such as by flip through individual room options and not relatively positioned. Alternatively, signal attenuation may be used to map lights between rooms.

Applications in the form of a few lights is no arduous task to do manually; however, when the number of light nodes increases, such as to dozens or even hundreds, like in the case of a commercial office, it is a very difficult to configure these systems manually.

The mapping can be done using many different techniques using physics, math and wireless disciplines. These may include, but are not limited to adjusting the power level from very small to very large with an encoded signal so the receiving light knows the transmitting light's power level and the receiver also uses RSSI (Receiver Signal Strength Indication) or Time of Flight for the signal to determine relative and sometimes absolute distance. RF, Bluetooth, NFC, light, ultrasound, and other communication methods, devices, and mediums may be used alone or in combination to map a system of lighting devices.

These lights, are also called nodes in a ceiling. They can be in a ceiling, but can also be on a floor, or on walls and other locations. For the purpose of exemplary embodiments described herein, the configuration includes positions on a flat surface like a floor or ceiling, roughly along the same plane but not limited to the same plane.

Once the automatic mapping is complete, which could take only a few minutes for a normal size office environment or even seconds for a home, the map can be automatically displayed on the smart device like a tablet or smart phone.

Once the map has formed, representing the lights on the display, the user can use the display interface to control the lights. In an exemplary embodiment, the control device comprises a touch screen. In an exemplary embodiment, a lasso or encompassing motion may be used to group together certain quantity of lights and easily associate a grouping of lights to a specific physical light switch node that also contains a wireless device and is part of this wireless communicating network of devices. Once associated, the light switch can thereafter be used to turn those lights on or off, or control their brightness wirelessly.

The system can self-map where there are lights and allow the user to associate light switches to lights in every room of a home or office just as easily as the first room, without the need for complex manual mapping and manual identification.

A physical wall mounted light switch is not required, as the smart phones or tablets themselves can be used to control the lights as well. Embodiments described herein may also be controlled through the web (cloud, internet) as well. The same image displayed on the smart device (iPhone/Tablet) can also be displayed anywhere in the world to authorized users for control.

A user can also easily choose to select options like 50% lighting, or some other interval. The system may engage a dimming control or selectively illuminating an associated percentage of sockets. For example, if there is no dimming control, and a user selects 50% lighting, then every other light can be turned on and intermittent lights turned off to help conserve energy.

In exemplary embodiments, the wireless devices mounted in the light fixtures that control the lights can do much more than just control lights.

There can be a light sensor at the lighting node which monitors the light so if the signal is sent to the light to turn on, and it is not emitting enough photons as expected for the amount of drive current, then that feedback can be reported as a bulb not working or not working properly and needing service.

The wireless node in the light fixture can also be used as a beacon where it can emit and/or receive a signal from a person or device containing a tracking tag or a smart phone that can be used to identify where people or objects are in a home or building and control lighting set to your own personal settings or for saving energy.

A microphone, PIR (passive infrared), ultra sound reflection, carbon, temperature, carbon dioxide, methane, natural gas, fire and many other types of sensors can be placed in the light fixture and connected to the wireless device to allow monitoring of the whole home or office for security, safety, energy savings or convenience.

This system of auto-deployment and self-pattern-identification can be used with all types of nodal devices, not only lights. They can be used in applications of parking sensors and even mobile applications where quick and adaptive mapping is needed.

The wireless lighting system can also be used as fire alarms with detectors at each or every few nodes which can report back information to a central location, or alert the other nodes to alert all those nearby of an emergency.

The many wireless devices being located in a home in the lights can act as local beacon receivers, receiving signals from asset tracking tags throughout a home or office allowing you to find your item's indoor location.

The wireless devices can also be used to control the lights to provide direction in the event of a fire by lighting certain lights in a blinking fashion, leading people to safety exits.

In construction applications, lights according to embodiments described herein may be configured to blink and placed in random locations. They can all automatically map and report their locations relative to each other.

In an exemplary embodiment, the graphical display with mapping may comprise “graph layout” as used in graphical layout engines.

Each node or any combination of nodes, regardless of its embodiment, (lighting device or controller), such as a light switch, which can be one or many, or the light fixtures themselves, can serve as a repeater to extend the communication coverage area to very long lengths and even from floor to floor in a large structure.

Information collected through one or more exemplary embodiments (for example, use rates, maintenance, life, efficiency, temperature, illumination level, chemical compositions, etc.), can reside in one or more of the nodes, which can be a switch or a light fixture wireless unit. That unit can hold the mapping information, also the mapping information and/or associated information can also be held in the “cloud” web, a mobile device, a controller or other console unit, or on a smart device as well.

Embodiments described herein may also have other applications. For example, exemplary near-field, automatic mapping can also be used in an application where you have large groups of people in a stadium like a football filed, or in the stands (seats), all of the people in the stadium would use their cell phones equipped with a special software application, that uses the on-board bluetooth low energy, wifi, NFC or other type of wireless device which allows for distance measurement, to determine an individual location relative to the adjacent person or device and the person next to them, similar to the lighting application indoors in a home or office.

Once this mapping information is automatically collected, it would all be wirelessly communicated through the cellular or other type of network to report the mapping location to a website or similar common collection and management node for use to control lights or sounds from a common point as in the following application:

10,000 people all at once hold their cell phones up while running this special mapping app. Each phone represents a pixel like on a large screen monitor and real-time graphics and images, and large text can be displayed with each person serving as a pixel in a large display over hundreds of feet in size.

Light is one option, sound emitted from each device on its own or in parallel is another option.

Yet another application is with cars driving on the road sending and receiving information to and from each other relating to distance.

Yet another application includes a parking lot application like in an auto-dealership, in which a node placed in each car can identify its relative location and produce a real-time updated map of where all the cards are located at any given time for easy tracking and location as cars are driven in and out of the lot. In this embodiment, used and available spaces may be easily located and tracked.

What is claimed is:

1. A lighting device, comprising:
an electronic switch that is controlled by an embedded wireless device in the lighting device; the wireless device configured to receive signals from a controller and control the electronic switch according to the received signals.

2. The lighting device of claim 1, wherein the electronic switch is configured to cause the flow or disruption of flow of current to a light bulb, thereby turning a light associated with the lighting device on, off, or dim.

3. The lighting device of claim 2, further comprising a sensor to map a relative location of an adjacent lighting device in a system of lighting devices.

4. A system of lighting devices, comprising a plurality of lighting devices according to claim 3.

5. The system of claim 4, wherein the plurality of lighting devices are configured to map a relative location relative to adjacent lighting devices of the plurality of lighting devices.

6. The system of claim 4, further comprising a controller having a visual display, wherein the lighting devices communicate wirelessly with the controller.

7. The system of claim 6, wherein the controller comprises a user interface for selecting one or more lighting devices to turn on and off.

8. The system of claim 7, wherein the user interface permits a selection and grouping of two or more lighting devices to be controlled by a single controlling interface.

9. The system of claim 7, wherein the user interface is configured to mate a controller of a switch to one or more lighting devices.

10. The system of claim 7, further comprising at least one sensor within one or more of the plurality of lighting devices.

11. The system of claim 10, wherein the at least one sensor is configured to measure temperature, illumination, chemical composition, or combinations thereof.

12. The system of claim 11, wherein at least another of the at least one sensor is configured to detect carbon monoxide, methane, natural gas, other desired substance, or combinations thereof.

13. The lighting device of claim 3, further comprising a housing enclosing the electronic switch having:
a male connector configured to insert into a traditional light fixture; and
a female connector configured to receive a light.

14. The lighting device of claim 3 integrated with a light bulb.

15. The lighting device of claim 3, configured to automatically map a relative location of an adjacent lighting device, and wirelessly communicate with a controller for programming the lighting device, and wirelessly communicate to receive power level instructions from a switch designated through the controller.

16. A method of installing a smart lighting system, comprising:
installing one or more lighting devices at one or more conventional light fixtures, the lighting device comprising an automatic mapping system and wireless control system;
initiating the automatic mapping system such that a map of the one or more lighting devices is created on a controller having a display;
assigning light switches to one or more of the one or more lighting devices through the controller.

17. A method of controlling a plurality of light or audio sources, comprising:
activating a program stored in the light or audio source to determine the proximity of an adjacent light or audio source;
sending the determined proximity to a remote controller to map a plurality of light or audio sources;
using the remote controller to communicate to the light or audio source to send lighting or audio instructions to control the plurality of light or audio sources as a single unit, such that each light or audio source acts as a pixel or point source within the larger single unit.

18. The method of controlling a plurality of light or audio sources of claim 17, wherein the light or audio source is a mobile smart phone.

19. A method of tracking a plurality of objects, wherein each object includes a proximity detector to determine its location relative to adjacent objects and a communication device to send the determined location to a controller, comprising:
determining each object's proximity to adjacent objects using the proximity detector of the object;
sending proximity information to a controller with the communication device;
mapping the location of the plurality of objects received at the controller.

20. The method of tracking the plurality of objects of claim 19, wherein the mapping is used to determine free and used space among the plurality of objects.

21. The method of tracking the plurality of objects of claim 19, wherein the mapping is used to locate a specific object among the plurality of objects.

22. The method of tracking the plurality of objects of claim 19, wherein the mapping is used to determine, track, or control desired distances between the plurality of objects.
